(19) United States
(12) Patent Application Publication
(10) Pub. No.: US 2007/0243961 A1
(43) Pub. Date: Oct. 18, 2007

(54) RATCHETING TENSIONER WITH OVERRIDE

(75) Inventor: Michael G. Aimone, Belleville, MI (US)

Correspondence Address: BIR LAW, PLC/FGTL, 13092 GLASGOW CT., PLYMOUTH, MI, 48170-5241, US

(73) Assignee: FORD GLOBAL TECHNOLOGIES, LLC, Dearborn, MI (US)

(21) Appl. No.: 11/307,381

(22) Filed: Feb. 3, 2006

(51) Int. Cl. F16H 7/08; F16H 7/22

(52) U.S. Cl. 474/109; 474/110; 474/111

(57) ABSTRACT

Sustained over-tensioning of a power transmission device, such as a chain drive in an internal combustion engine, is prevented by overriding a tensioner ratchet mechanism to permit retraction of a tensioner. Tooth angle of the ratchet mechanism and pawl spring rate and preload are selected so that a sufficient axial force generated by chain/belt tension will produce a transverse force that overrides a biasing force acting on a pawl engaging a rack of the ratchet mechanism to retract a tensioning piston against hydraulic pressure and spring pressure by at least one tooth to reduce the sustained tensioning force applied to the chain/belt, while not adversely affecting the rack extension function. The tooth geometry of the pawl and/or rack of the ratcheting mechanism may have an angle chosen to be slightly less than the self-locking friction angle to permit retraction.

### BACKGROUND OF THE INVENTION

1. Field of the Invention

The present invention relates to systems and methods for maintaining proper tension in a chain or belt using a hydraulic or mechanical tensioning system incorporating a ratcheting mechanism that reduces or prevents sustained over-tensioning by permitting bidirectional tensioner movement under certain loading conditions.

2. Background Art

Internal combustion engines typically use a number of power transmission devices, such as belts and/or chains, to power or drive various engine components or accessories. Insufficient tension or excessive tension may result in undesirable noise, belt slipping, chain jumping, or accelerated component wear. A tensioner is a device that is used to provide proper tension of the chain/belt under various ambient and operating conditions and to reduce or prevent tooth jumping of a chain, or slipping of a belt, while providing damping to control drive system dynamics, as well as accommodating changing distances between driving/driven components due to various factors including manufacturing tolerances/variations, thermal expansion and contraction, component wear, chain/belt wear, etc.

One type of tensioning mechanism that may be used to maintain proper tension of a timing belt or chain, which connects a camshaft to the crankshaft of an engine, is a ratcheting hydraulic tensioner. This type of tensioning mechanism uses hydraulic pressure and/or a mechanical spring to advance a piston that applies tension to the chain/belt through a tensioning arm, thereby taking up excessive chain or belt slack and maintaining desired chain or belt tension under all drive torque magnitudes and senses, and operating temperatures. A spring-loaded ratchet mechanism in the tensioner limits retraction (collapse) of the piston when hydraulic pressure is removed, such as when the engine is not running. Most hydraulic ratcheting tensioners are designed to support the load from chain tension primarily via the hydraulic piston during normal operation, while the ratchet is used to limit the amount of reverse travel (retraction of the piston) in the case that the piston cannot hydraulically support the load, as in normal shutdown and startup conditions or in certain other conditions previously discussed. However, over-tensioning of the chain can occur during a low temperature engine startup due to more viscous hydraulic fluid or oil and momentary high oil pressure acting on the piston, as well as higher driven component friction loading, especially when the operator revs the engine immediately after starting. If the ratchet mechanism engages an additional tooth while the piston is hyper-extended, the ratchet mechanism will prevent any subsequent retraction or collapse and, any further increase in chain tension caused by thermal growth of engine components cannot be reduced or relieved by tensioner collapse. In effect, the over-extension of the tensioner piston and corresponding locking into position of the ratchet rack effectively eliminates any hydraulic damping provided by the tensioner piston that would otherwise be present via the allowable distance established by design between the tensioner ratchet rack and the tensioning arm that allows adequate piston motion under normal operating conditions, or via the backlash designed into certain ratcheting piston concepts. This resulting sustained over-tension condition may produce undesirable noise and/or premature wear of various components, including the timing belt/chain and camshaft bearings, for example.

Various solutions to over-tensioning of a hydraulic ratcheting tensioner include a pressure relief mechanism that lowers the effective damping force of the tensioner to mitigate effects of momentarily high oil pressure, oil viscosity and/or system input loads, such as disclosed in U.S. Pat. Nos. 4,822,320 and 5,720,684, for example. Reducing the damping force of the tensioner by increasing hydraulic leakage past the piston or providing a separate leak path may result in poor tension control at higher oil temperatures where the oil is less viscous. The reduced hydraulic damping at higher temperatures may also lead to mechanical loading of the ratchet mechanism teeth and resulting noise, vibration, and harshness (NVH) and durability concerns. In addition, while these hydraulic-related solutions may prevent the tensioner piston and/or ratchet rack from being over-extended due to momentary high operating pressure, they do not relieve an over-tension condition that may result from various other operating conditions.

### SUMMARY OF THE INVENTION

The present invention provides systems and methods for maintaining desired tension in a power transmission device, such as a chain drive in an internal combustion engine, by overriding the ratchet mechanism to permit retraction of the tensioner. The tooth angle of one or more ratchet mechanism components is selected such that an opposing force greater than a predetermined threshold permits retraction or backward travel of the tensioner to prevent sustained over tensioning of the power transmission device.

In one embodiment of the present invention, the tooth geometry of the ratchet mechanism is selected so that when a sufficient axial force is applied to the tensioner piston and/or ratchet rack via chain/belt tension, a transverse force will be generated to override a biasing force acting on the ratchet mechanism to allow retraction of the piston and/or ratchet rack by at least one tooth to reduce the over-tensioning force applied to the chain/belt. The tooth geometry of a pawl and/or rack of the ratcheting mechanism may have an angle chosen to be slightly less than the self-locking friction angle to permit retraction. A spring associated with the pawl is sized to allow pawl and rack retraction under sufficiently high axial loads, but prevent rack retraction or piston collapse when hydraulic pressure drops, such as when the engine is shut down.

The present invention provides a number of advantages. For example, the present invention maintains proper tension in a chain-driven or a belt-driven device while preventing sustained over-tensioning by allowing reverse travel of the tensioner piston and/or ratchet rack when subjected to a sufficiently high axial load. The present invention does not rely on a hydraulic pressure relief valve or leakage past the tensioning piston, which are generally unresponsive to rapid increases in hydraulic pressure, resulting in more robust chain tension control under wider temperature variations. The present invention eliminates sustained over-tensioning of a chain/belt regardless of the underlying cause or source(s) of the over-tensioning.

The above advantages and other advantages and features of the present invention will be readily apparent from the following detailed description of the preferred embodiments when taken in connection with the accompanying drawings.

### BRIEF DESCRIPTION OF THE DRAWINGS

FIG. 1 illustrates a ratcheting hydraulic tensioner with override according to one embodiment of the present invention in a representative chain drive application; and

FIG. 2 illustrates operation of a system or method for preventing over tensioning of a power transmission device by a ratcheting tensioner according to one embodiment of the present invention.

### DETAILED DESCRIPTION OF THE PREFERRED EMBODIMENT(S)

As those of ordinary skill in the art will understand, various features of the present invention as illustrated and described with reference to any one of the Figures may be combined with features illustrated in one or more other Figures to produce embodiments of the present invention that are not explicitly illustrated or described. The combinations of features illustrated provide representative embodiments for typical applications. However, various combinations and modifications of the features consistent with the teachings of the present invention may be desired for particular applications or implementations.

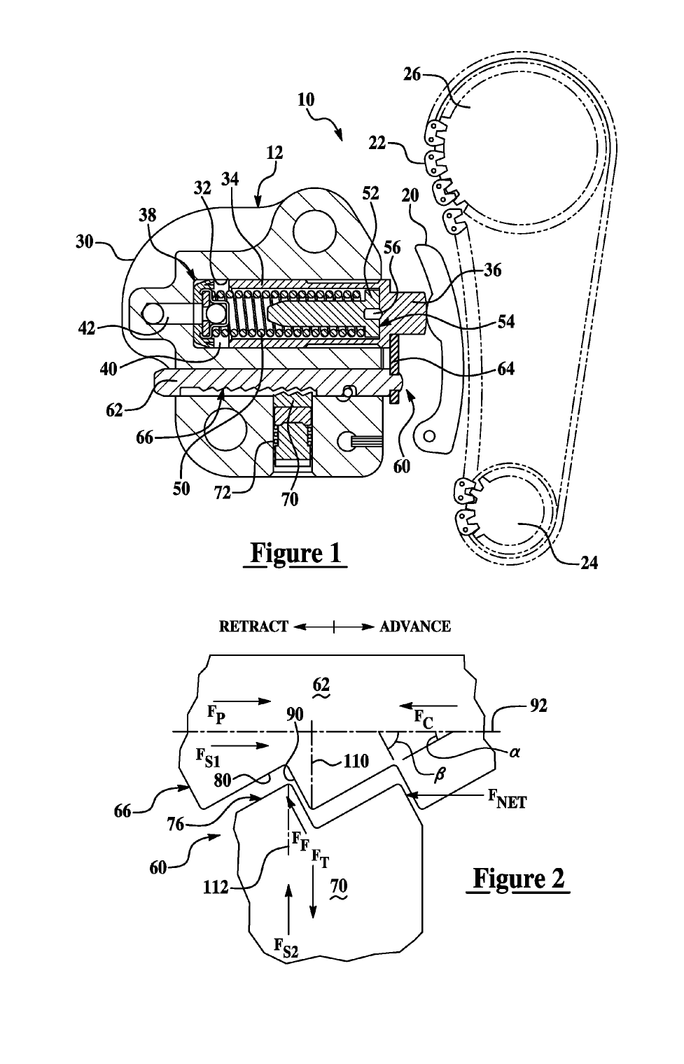

Referring now to FIG. 1, a ratcheting hydraulic tensioner having a ratchet override according to the present invention is illustrated in a representative application. As previously described, a tensioner according to the present invention may be used in a wide variety of applications to provide proper tension and control of a chain or belt in a power transmission device. Although described with reference to a hydraulic tensioner, those of ordinary skill in the art will recognize that the present invention is not limited to hydraulic tensioners. Some mechanical tensioners offer damping (for example leaf spring tensioners and coil spring tensioners that incorporate friction damping), and could incorporate a ratcheting feature with override according to the present invention to provide advantages and benefits similar to those described herein with reference to a hydraulic tensioner.

In the representative embodiment illustrated in FIG. 1, system 10 includes a ratcheting hydraulic tensioner 12 (shown in cross-section) with an associated tensioner arm 20 that applies tension to the slack side of chain 22, which is wrapped around crankshaft sprocket 24 and camshaft sprocket 26 of an internal combustion engine (not shown). For belt-driven power transmission devices, a belt would be used in the place of chain 22 with pulleys or sheaves used in the place of sprockets 24, 26. Toothed synchronous belts would use appropriately toothed pulleys or sprockets.

Tensioner 12 includes a housing 30 having a cylindrical bore 32 with a hollow plunger or piston 34 disposed therein. Piston 34 includes one end 36 that protrudes from housing 30 and contacts tensioner arm 20 to apply tension and/or damping force to chain 22. A check valve assembly 38 is disposed at one end of bore 32 to control flow direction of hydraulic fluid or oil into high pressure chamber 40 from a fluid passageway or reservoir 42. Check valve assembly 38 includes a spring biased ball that allows fluid to enter chamber 40 but prevents fluid from returning to passage 42 to pressurize chamber 40. A tensioner piston biasing spring 50 is disposed within the interior of hollow piston 34 and extends between check valve assembly 38 and a volume control pin 52 that contacts piston 36. Pin 52 extends within spring 50 and operates to reduce the volume of hydraulic fluid within chamber 40 during operation to provide a desired level of damping. Pin 52 may include a corrugated end 54 having a channel or pocket 56 to provide a leakage path for fluid to exit chamber 40 to effectively regulate pressure within chamber 40 as piston 36 moves within bore 32, and/or provide venting of unwanted air from the high pressure chamber, and/or provide a metered lubrication source to components external to the tensioner.

Tensioner 12 includes a ratchet mechanism or assembly 60 that operates to limit retraction of arm 20 when piston 34 retracts into housing 30. In this embodiment, ratchet mechanism 60 includes a rack 62 disposed within housing 30 having a connecting member or arm 64. Extension or advancement of piston 36 contacts arm 64 to move arm 64 and rack 62 toward tensioner arm 20. Rack 62 includes a plurality of teeth 66 that engage corresponding teeth on an associated pawl 70 that travels transversely relative to rack 62 within an associated bore in housing 30. A pawl spring 72 exerts a biasing force on pawl 70 so that the teeth on pawl 70 engage the teeth on rack 62 and limit retraction or movement of tensioner arm 20 when hydraulic pressure within chamber 40 drops, such as when the engine is shut off. This maintains sufficient tension in chain 22 to avoid jumping sprocket teeth during continued operation or when the engine is restarted in the absence of sufficient hydraulic pressure. Both the slack and tight strands of a cam drive system, for example, experience alternating high and low tension levels due to the nature of the torque reversals of the driven camshaft, caused by compression and release of the engine valve springs, as well as drive system dynamics. If the engine is stopped in a position where tension is being applied to the strand in contact with the tensioner, as oil pressure depletes the tensioner can and will tend to collapse hydraulically, unless prevented mechanically, such as with a ratchet mechanism.

In operation, tensioner piston spring 50 provides an initial bias to advance piston 34 against tensioner arm 20 and exert a tensioning force on chain 22, and to take up excessive slack in the chain/belt strand. Pressurized oil or other hydraulic fluid is provided to passage 42 and enters chamber 40 through check valve assembly 38. Pressure within chamber 40 exerts an additional extending force on piston 34 proportional to the surface area of piston 34. Pressure within chamber 40 is controlled or regulated by controlling the leakage rate past piston 34 and/or through one or more leakage paths, such as provided by surface 54 and pocket 56, for example. Temperature variations, component wear, or other factors result in corresponding variations in tension of chain 22. As the tension of chain 22 is reduced, hydraulic pressure in chamber 40 in combination with spring force of spring 50 advances piston 34 and associated rack 62. The angle of rack teeth 66 and corresponding teeth on pawl 70 operate to move pawl 70 against pawl spring 72 as piston 34 and rack 62 advance and increase tension on chain 22. Reverse travel or retraction of piston 34 is generally limited to what is required for normal hydraulic operation of the tensioner, as well as allowing for thermal growth of engine components, while not allowing enough collapse that would make tooth jump a possibility during a subsequent engine startup. The allowable reverse travel is controlled by the choice of pitch or distance between adjacent rack/pawl teeth, as well as the distance the tensioner piston can retract before tensioner arm 20 contacts the ratchet mechanism rack arm or member 64.

In conventional hydraulic ratcheting tensioners that do not include an override according to the present invention, the teeth of ratchet mechanism 60 are designed to provide a mechanical no-return limiter function, i.e. once the ratchet mechanism advances, the return or retraction is limited to the distance allowed by design through choice of ratchet pitch as well as built in backlash as discussed above, for normal operating conditions. Stated differently, conventional tensioners use a ratchet mechanism with zero-return or no-return meaning the ratchet mechanism will not return to a previous tooth position. As previously described, for internal combustion engine applications, various ambient or operating conditions may occur that result in rack 62 being hyper-extended or advanced to a position that imposes a sustained undesirable tensioning force on chain 22, especially after further thermal growth of various engine components. This over-tensioning may be caused by a sudden increase in hydraulic pressure related to a cold start and revving of the engine, or by a momentary slackening of chain 22 associated with drive system resonance, or extreme driven component friction loading, for example. The conventional no-return ratchet mechanisms sustain this over-tensioned condition, which may result in undesirable noise and/or reduced component life.

According to the present invention, tensioner 12 includes a ratchet mechanism 60 that advances and maintains a position to prevent excessive piston collapse when piston tensioning force is reduced, such as when hydraulic pressure drops, similar to a conventional no-return mechanism, but includes an override feature that allows retraction when subjected to a sufficiently high axial load to prevent sustained over-tensioning of chain 22. As such, if piston 34 is over-extended by a sudden increase in hydraulic pressure in chamber 40, or unusually high torque load on the driven shaft, or for any other reason that creates an undesirable over-extension of the ratchet rack position resulting in a sustained over-tension in chain 22, the subsequent increased axial load retracts piston 34 and ratchet mechanism 60 by at least one tooth so that the tension is reduced and sustained over-tensioning is eliminated. As described in greater detail below with reference to FIG. 2, ratchet mechanism 60 may include teeth having an angle selected to generate a transverse force sufficient to disengage pawl 70 from rack 62 by moving pawl 70 against pawl spring 72 and away from rack 62 in response to a predetermined axial load to allow retraction of piston 34 and rack 62 by at least one tooth pitch distance to reduce tension of chain 22.

While FIG. 1 illustrates rack 66 as a separate element that extends or advances with piston 34, various other configurations are also possible depending on the particular application and implementation. For example, rack teeth may be integrated into piston 34, or rack 62 may be secured for movement with piston 34. Similarly, the function performed by pawl 70 to allow movement of rack 62 in one direction and inhibit movement in the opposite direction does not necessarily require a spring loaded cylindrical pawl positioned transversely to rack 62. Other configurations may include a pivoting rocker with an engaging tooth, etc.

FIG. 2 illustrates operation of a representative ratchet mechanism with an integral ratchet override for use in a hydraulic tensioner according to one embodiment of the present invention. Those of ordinary skill in the art will recognize that a ratchet mechanism according to the present invention may be implemented as illustrated in FIG. 1, or may be an integral part of tensioning piston 34. Various other implementations consistent with the teachings of the present invention are possible and depend on the particular application. In the representative embodiment of ratchet mechanism 60 shown in FIG. 2, pawl 70 includes a plurality of teeth 76 that engage corresponding teeth 66 of rack 62. Each tooth 66 of rack 62 and each tooth 76 of pawl 70 includes an advancing surface 80 and a retracting surface 90. Advancing surfaces 80 of teeth 66, 76 are generally longer and form a smaller angle, alpha, relative to axial centerline 92 compared to retracting surfaces 90, which are generally shorter and form a larger angle, beta, relative to axial centerline 92. This arrangement requires a smaller axial force in the advancing direction to move rack 62 with a significantly larger force required to override the ratchet and move rack 62 in the retracting direction according to the present invention. As described above, conventional zero-return or no-return ratchet mechanisms are designed to prevent rack 62 from disengaging pawl 70 and retracting to another tooth in the retracting direction. The present inventor has recognized that the zero-return or no-return function has been provided by positioning retracting surface 90 at a right angle or substantially perpendicular to axial centerline 92. As such, one method of providing a ratchet override according to the present invention is to position the retracting surface 90 of teeth 66, 76 at an acute angle beta, i.e. at an angle beta of less than ninety degrees. The general range of acceptable values for angle beta may be determined based on the desired net axial force necessary to generate a transverse force that opposes the spring force acting on pawl 70 to disengage pawl 70 from rack 62 and allow retraction of the tensioning piston. General considerations in determining an appropriate value or range of values for one representative embodiment is described below.

In the representative embodiment of a ratcheting tensioner with override as illustrated in FIGS. 1 and 2, the primary axial forces acting to advance rack 62 include a force Fₚ corresponding to the force of the hydraulic pressure acting on tensioning piston 34 and a spring force Fₛ₁ corresponding to the force produced by spring 50 disposed within piston 34. These combined axial forces have a transverse or perpendicular component based on angle alpha of advancing surfaces 80 that acts against the spring force of pawl spring 72 to move pawl 70 away from rack 62 so that rack 62 advances along with tensioning piston 34 to apply tension to arm 20 and chain 22 until the combined axial forces associated with spring 50 and piston 34 (less the axial component of pawl spring 72 and a frictional component associated with advancing surfaces 80 which is proportional to the force component normal to the two contacting surfaces 80) is substantially equal to the opposing force supplied by tension of chain 22, represented by F_{c}.

If hydraulic pressure drops, such as when the engine is shut down, for example, the resulting axial force F_{c} moves tensioning piston 34 in the retracting direction until arm 20 contacts rack arm 64, then moving rack 62 in the retracting direction until the retracting surfaces 90 of rack 62 and pawl 70 contact each other. Angle beta is selected so that an acceptable tension in chain 22 and the resulting axial force is not sufficient to cause significant movement of pawl 70 against force F_{S2} of pawl spring 72 so that teeth 76 of pawl 70 remain engaged with teeth 66 of rack 62 preventing any additional movement of rack 62 in the retracting direction. As such, acceptable tension of chain 22 is maintained to avoid tooth jump at engine startup prior to hydraulic pressure being restored.

If any operating conditions occur that overextend piston 34 and rack 62 and result in over-tensioning of chain 22, the ratchet override feature of the present invention will allow retraction of rack 62 and piston 34 to prevent sustained over-tensioning. According to the present invention, appropriate sizing or selection of angle beta will generate a transverse force F_{T} in response to an axial force or chain tension that exceeds a predetermined threshold that moves pawl 70 against pawl spring 72 to disengage teeth 76 from rack teeth 66. This allows rack 62 to retract by at least one tooth. Stated differently, the override feature of the present invention allows a rack tooth 66 having a centerline 110 to retract and move past at least one pawl tooth 76 having a centerline 112 to reduce tension on chain 22 in response to an undesirable tension in chain 22.

As recognized by the present inventor, a frictional force (F_{F}) acts along the retracting surface 90 of teeth 66, 76 and includes a transverse component that acts in the same direction as spring force F_{S2} opposing disengagement of pawl 70 from rack 62. The frictional force is proportional to the component of the net axial force acting normal or perpendicular to surface 90 (which depends on angle beta) and the effective coefficient of friction of surfaces 90, taking into consideration base materials and any coating or lubricant. As such, there is a “self-locking friction angle” value of angle beta, such that any angle beta chosen equal to or greater than that value will result in pawl 70 remaining engaged with no retraction by one or more teeth, no matter how much the axial load Fnet (net axial load applied to rack from over-tension condition) is increased. As such, to provide a ratchet override feature according to the present invention, angle beta should be selected to be less than the self-locking friction angle. However, because over-tensioning that may result in undesirable noise or reduction of component life generates axial forces that significantly exceed normal operating forces, acceptable operation of an override feature according to the present invention should not necessitate an extremely precise range of acceptable values for angle beta or pawl spring force, while still allowing appropriate function under normal operating conditions.

As illustrated and described with reference to FIGS. 1 and 2, a system or method to prevent over-tensioning of a power transmission device according to the present invention operates by disengaging ratchet mechanism 60 of tensioner 12 in response to tension of the power transmission device exceeding a predetermined threshold. In the illustrated embodiment, ratchet mechanism 60 includes a rack 62 having a plurality of teeth 66 that engage corresponding teeth 76 of a pawl 70 and the step of disengaging pawl 70 includes moving pawl 70 away from rack 62 using an axial force F_{c} generated by tension of the power transmission device 22. Rack teeth 66 and pawl teeth 76 have retracting surfaces 90 disposed at an angle beta to generate a transverse force F_{T} that opposes pawl spring 72 and disengages pawl teeth 76 from rack teeth 66 in response to the axial force generated by over-tensioning of the power transmission device 22. The transverse force F_{T} compresses pawl spring 72 to allow disengaging of pawl 70 from rack 62 to allow a centerline 110 of at least one rack tooth 66 to travel past the centerline 112 of at least one pawl tooth 76 to reduce tension of power transmission device 22. The number of pawl teeth 76 traversed during any particular retraction to relieve over-tensioning may vary depending upon the over-tensioning force, the pawl spring force, the distance between adjacent teeth or tooth pitch of the ratchet mechanism, hydraulic pressure, etc. After retracting one or more teeth, the force generated by hydraulic pressure and tensioner spring pressure will subsequently advance the tensioning piston to apply an appropriate tension to the power transmission device.

As such, the present invention operates to maintain proper tension in a power transmission device while preventing sustained over-tensioning by allowing reverse travel of the tensioner ratchet rack and piston when subjected to a sufficient axial load. The present invention does not rely on a hydraulic pressure relief valve or leakage past the tensioning piston, solutions that are generally unresponsive to rapid increases in hydraulic pressure, especially under high oil viscosity conditions, resulting in more robust tension control under wider temperature variations. By including a ratchet mechanism with override, the present invention eliminates sustained over-tensioning of a power transmission device regardless of the underlying cause or source(s) of the over-tensioning.

While the best mode for carrying out the invention has been described in detail, those familiar with the art to which this invention relates will recognize various alternative designs and embodiments for practicing the invention as defined by the following claims.

What is claimed is:

1. A method for preventing over-tensioning of a power transmission device having a hydraulic tensioner with a ratchet mechanism, the method comprising:
disengaging the ratchet mechanism in response to tension of the power transmission device exceeding a predetermined threshold.

2. The method of claim 1 wherein the ratchet mechanism includes a rack having a plurality of teeth that engage corresponding teeth of a pawl, and wherein the step of disengaging comprises moving the pawl away from the rack using an axial force generated by tension of the power transmission device.

3. The method of claim 1 wherein the ratchet mechanism includes a rack having a plurality of teeth, a pawl having a plurality of teeth, and a spring biasing the pawl into contact with the rack, and wherein the rack teeth and pawl teeth have a retracting surface disposed at an angle to generate a transverse force that opposes the spring and disengages the pawl teeth from the rack teeth in response to a predetermined axial force generated by tension of the power transmission device.

4. The method of claim 1 wherein the ratchet mechanism includes a rack having a plurality of teeth and a pawl having at least one tooth with an associated centerline and wherein the step of disengaging comprises disengaging the pawl from the rack to allow a centerline of at least one rack tooth to travel past the centerline of the at least one pawl tooth.

5. A tensioner for a power transmission device, the tensioner comprising:
a housing having a bore;
a piston disposed within the bore and having a portion extending from the housing to maintain tension in the power transmission device;
a ratchet mechanism associated with the piston, the ratchet mechanism retracting with the piston to reduce tension of the power transmission device in response to tension of the power transmission device exceeding a predetermined load.

6. The tensioner of claim 5 wherein the ratchet rack is extended by the piston contacting a connecting member fixed to the rack.

7. The tensioner of claim 5 wherein the ratchet mechanism comprises:
a rack having a plurality of teeth;
a pawl positioned to selectively engage the rack to prevent retraction of the rack and piston when a piston tensioning force is reduced, wherein the pawl disengages the rack in response to tension of the power transmission device exceeding the predetermined load.

8. The tensioner of claim 7 wherein the plurality of rack teeth include a retracting surface that forms an angle relative to an axial centerline that generates a transverse force sufficient to move the pawl away from the rack when an axial load from the power transmission device exceeds the predetermined load.

9. The tensioner of claim 8 wherein the angle is selected based on at least a coefficient of friction of the retracting surface and the pawl spring load.

10. An internal combustion engine having a crankshaft coupled to at least one camshaft by a power transmission device with an associated tensioner, the tensioner comprising:
a housing having a bore;
a hollow piston disposed within the bore and defining a pressurized chamber therein, the piston having an end extending from the housing and contacting a tensioner arm to apply tension to the power transmission device;
a valve for admitting pressurized hydraulic fluid into the chamber;
a piston spring disposed in the bore in the hollow piston and extending between the valve and the piston;
a ratchet mechanism associated with the piston, the ratchet mechanism allowing the piston to advance under pressure from the pressurized hydraulic fluid and the piston spring to move the tensioner arm to apply tension to the power transmission device and limiting retraction of the piston until tension of the power transmission device exceeds a predetermined load.

11. The internal combustion engine of claim 10 wherein the ratchet mechanism comprises:
a rack having a plurality of rack teeth;
a pawl positioned to engage the rack teeth with a predetermined pawl force to limit retraction of the rack when hydraulic pressure drops, wherein the rack moves the pawl away from the rack to disengage the plurality of rack teeth in response to over tensioning of the power transmission device.

12. The internal combustion engine of claim 11 wherein the rack teeth include a retracting surface positioned at an angle to generate a force exceeding the predetermined pawl force to move the pawl away from the rack in response to a predetermined tension of the power transmission device.

13. The internal combustion engine of claim 10 wherein the power transmission device comprises a chain.

14. The internal combustion engine of claim 10 wherein the power transmission device comprises a belt.

15. The internal combustion engine of claim 10 wherein the ratchet mechanism comprises:
a rack disposed within the housing in a bore generally parallel to the piston and having a plurality of rack teeth;
a pawl disposed within the housing transverse to the rack, the pawl having a plurality of pawl teeth;
a pawl spring positioned within the housing to bias the pawl toward the rack;
wherein the rack teeth and pawl teeth have retracting surfaces disposed at an angle to generate a transverse force to move the pawl against the pawl spring so that the pawl teeth disengage the rack teeth when the power transmission device exceeds a predetermined tension.

16. The internal combustion engine of claim 15 wherein the rack teeth and pawl teeth have advancing surfaces disposed at an angle to allow the piston to advance from the housing in response to hydraulic pressure and piston spring pressure to tension the power transmission device.

17. The internal combustion engine of claim 15 wherein the rack teeth and pawl teeth have retracting surfaces disposed at an angle that limits retraction of the piston until the tension of the power transmission device exceeds the predetermined load.

18. The internal combustion engine of claim 10 wherein the valve comprises a spring loaded check valve positioned to allow hydraulic fluid into the chamber and prevent hydraulic fluid from exiting the chamber through the valve.
